(19) United States
(12) Patent Application Publication
(10) Pub. No.: US 2026/0052092 A1
(43) Pub. Date: Feb. 19, 2026

(54) DATA TRAFFIC SOVEREIGNTY PROTECTION

(71) Applicant: Cisco Technology, Inc., San Jose, CA (US)

(72) Inventors: Jaganbabu Rajamanickam, Kanata (CA); Madhan Sankaranarayanan, Chinnamanur (IN); Vinay Saini, Bangalore (IN); Craig Thomas Hill, Sterling, VA (US); David Toscano, Nepean (CA)

(21) Appl. No.: 18/803,456

(22) Filed: Aug. 13, 2024

(51) Int. Cl. H04L 45/02; H04L 47/20

(52) U.S. Cl. CPC H04L 45/02; H04L 47/20

(57) ABSTRACT

This disclosure describes techniques for protecting data traffic sovereignty while routing data traffic across a network. The techniques include determining a geographic location of one or more network devices that may potentially be used in a data path for the data traffic. The techniques also include receiving a sovereignty policy related to the data traffic. The geographic location of the one or more network devices and the sovereignty policy may used to determine the data path for the data traffic. As such, data traffic sovereignty protection techniques may improve security in network communications.

### TECHNICAL FIELD

The present disclosure relates generally to the protection of sovereignty of data traffic, thereby improving security of data traffic across a network.

### BACKGROUND

Network environments are growing in complexity and scale to handle the ever-increasing demands on computer systems in the modern world. Computing often involves the movement of data traffic across wide-ranging networks of servers, routers, and other devices that provide computing resources to users such as communication, computing resources, networking resources, storage resources, database resources, application resources, and so forth. Privacy and data protection are important issues for many entities around the world, such as individuals, organizations, and even countries. Furthermore, complex issues arise when data traffic travels from one area to another.

Data sovereignty refers to the concept that an individual, organization, and/or country can control and maintain their own data, such as collection, storage, and interpretation of the data. Control of the data may be regulated by the legal framework of the country where the individual and/or organization resides or has citizenship. Data sovereignty may also refer to the concept that data stored outside of the host country of an individual or organization may be subject to laws of the country where it is stored. An organization may wish to enact rules regarding where data can be moved (or not), what areas the data can traverse, who has access to the data, and what one can do with certain data. For example, an organization may wish to consider issues related to data sovereignty when determining where data traffic may be allowed to move. Thus, the movement of data is becoming a critical issue for many organizations and/or countries as they try to control both the movement of their data as well as where the data are stored.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference to distinguish like elements. Use of the reference number without the associated parenthetical is generic to the element. The systems depicted in the accompanying figures are not to scale and components within the figures may be depicted not to scale with each other.

FIGS. 1A-1D illustrate component diagrams with example environments in which data traffic sovereignty protection concepts may be employed as part of communications between network devices, in accordance with the present concepts.

FIG. 2 illustrates an example call-flow diagram that may represent communications among network devices, in accordance with the present concepts.

FIGS. 3 and 4 illustrate examples of information that may be sent in messages as a part of communications among network devices, in accordance with the present concepts.

FIGS. 5 and 6 illustrate flow diagrams of example methods for the use of data traffic sovereignty protection concepts as a part of communications among network devices, in accordance with the present concepts.

FIG. 7 illustrates a block diagram illustrating an example packet switching system that can be utilized to implement various aspects of the technologies disclosed herein.

FIG. 8 illustrates a block diagram illustrating certain components of an example node that can be utilized to implement various aspects of the technologies disclosed herein.

FIG. 9 illustrates a computing system diagram illustrating a configuration for a data center that can be utilized to implement aspects of the technologies disclosed herein.

FIG. 10 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes, at least in part, a method that may be implemented by a controller device communicatively coupled to a head end device and one or more network devices. The method may include receiving, from the head end device, a path computation request for a data path. The data path may be intended for data traffic to travel across a network to a destination device. The method may also include receiving a geographic location of at least one network device of the network and a sovereignty policy related to the data traffic. Based at least in part on the geographic location of the at least one network device and the sovereignty policy, the method may include computing the data path for the data traffic. Finally, the method may include sending the data path for the data traffic to the head end device.

This disclosure also describes, at least in part, another method that may be implemented by a controller device communicatively coupled to a head end device and one or more network devices. The method may include receiving, from a head end device, a path computation request for a data path for data traffic across a network to a destination device. The method may include receiving a geographic location of a network device of the network. The method may also include receiving a sovereignty policy related to the data traffic. The method may include using the geographic location of a network device to determine a sovereignty authenticity index (SAI) value for the network device. Based at least in part on the SAI and the sovereignty policy, the method may include computing the data path for the data traffic. The method may further include sending the data path for the data traffic to the head end device.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for protecting data traffic sovereignty as the data traffic travels across a network. An organization may wish to ensure that the data traffic is protected from traveling across geographic areas in which sovereignty of the data traffic may be in jeopardy. In some implementations, a geographic location of one or more devices potentially involved in the data traffic routing may be considered. A policy regarding sovereignty of the data traffic may also be considered. For instance, the geographic location of the one or more devices and the policy regarding sovereignty may be used to inform routing of the data traffic.

Many countries around the world are working to protect their data by making data sovereignty a mandatory requirement. If data is transported through unauthorized jurisdictions, these countries feel that it compromises the security of the data. Recent improvements in Large Language Models (LLMs) have explored the possibility of predicting the content of encrypted data. Such improvements in LLM capabilities could heighten the risk of attackers being able to decrypt data. Furthermore, if data traffic were flowing through an unauthorized jurisdiction, it may be more difficult to monitor potential attackers who could attempt to tap into encrypted data.

Consequently, organizations and countries are striving to restrict the flow of secure data to within their own sovereignty, thereby gaining greater control over the data. A complication to data sovereignty is that in today's world, routing devices are not always stationary. Some routing devices may be mobile, such as on ships equipped with networking equipment that cross international waters, or Low Earth Orbit (LEO) satellites that continually travel an orbital path around the Earth. These types of mobile routing devices pose significant challenges in restricting data flow to a particular sovereignty.

Segment Routing (SR) is a network internet protocol/multiprotocol label switching (IP/MPLS) routing concept that embeds the path a packet should take within the packet header. SR can help streamline traffic engineering by using a list of segments as routing instructions. A segment routing, path computation element (SR-PCE) is a centralized controller that calculates optimal paths for traffic based on network constraints, such as bandwidth, latency, and policy requirements. However, typically an SR-PCE does not have an ability to consider a policy to provide a general sovereignty protection.

In the present dynamic data traffic sovereignty concepts, the SR-PCE controller may utilize the geographic location of one or more devices. For example, the devices could include a sending device, a receiving device, and/or a routing device, which may be a mobile routing device. The geographic location may be received from the one or more devices, or may be distributed through a data source such as interior gateway protocol (IGP), or border gateway protocol with link state (BGP-LS), for instance. The SR-PCE controller may also receive or access a Data Sovereignty Protection Intent (DSPI). For example, the DSPI may be provided by a user or organization, such as via a path computation element protocol (PCEP) interface or PCEP message. The SR-PCE may then apply the DSPI to restrict traffic flow with respect to the geographic location(s) of the one or more devices.

To summarize, a more efficient technique is presented for protecting sovereignty of data traffic flows for an organization, while considering complex network architectures which may include mobile routing devices. In some examples, dynamic data traffic sovereignty may be viewed as a relatively lightweight way to improve network operations and security, featuring both relatively low computational cost and relatively low bandwidth usage.

Although the examples described herein may refer to a SR-PCE controller (e.g., controller device), the techniques can generally be applied to any device in a network. For instance, the data traffic sovereignty protection concepts are expected to work within other approaches to traffic engineering, such as resource reservation protocol-traffic engineering (RSVP-TE), etc. Further, the techniques are generally applicable for any network of devices managed by any entity where data traffic is sent over a network, virtual resources are provisioned, and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may increase the security of data and/or reduce the amount of computational resource use, storage, dropped data, latency, and other issues experienced in networks due to lack of network resources, overuse of network resources, issues with timing of network communications, and/or improper routing of data. By improving network communications across a network, overall performance by and/or security related to servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

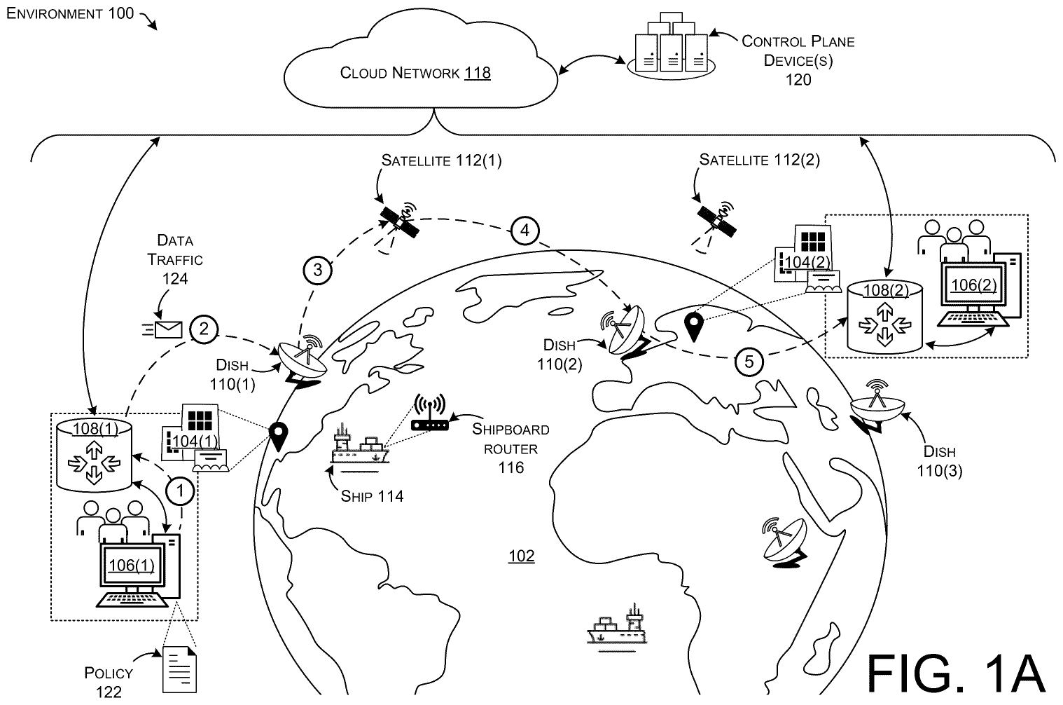

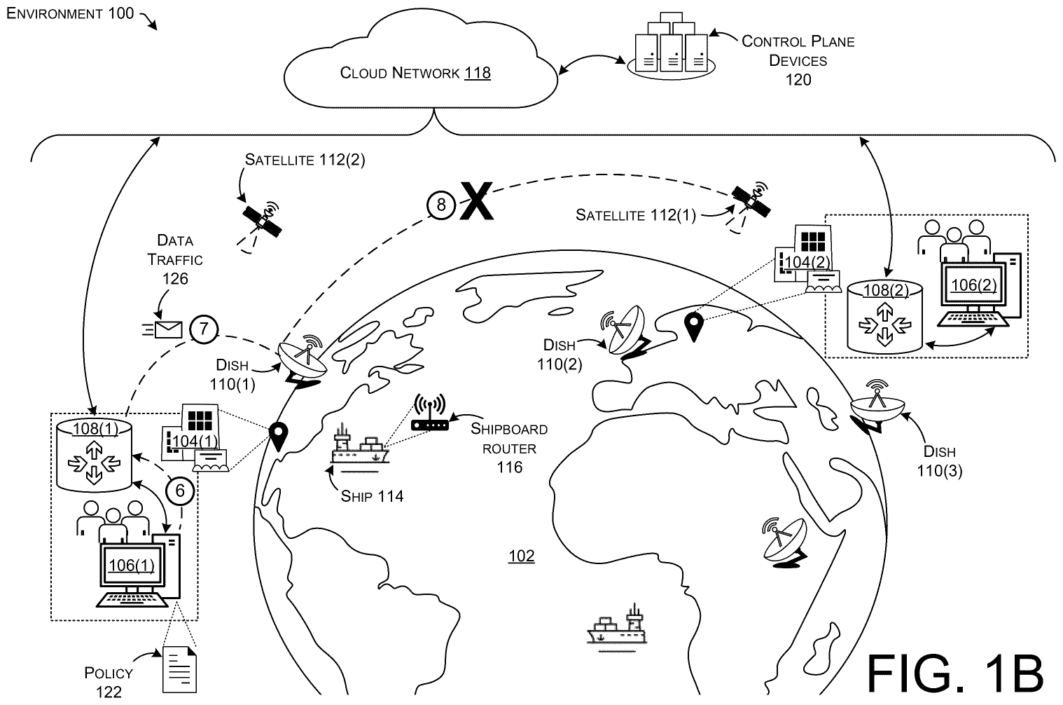

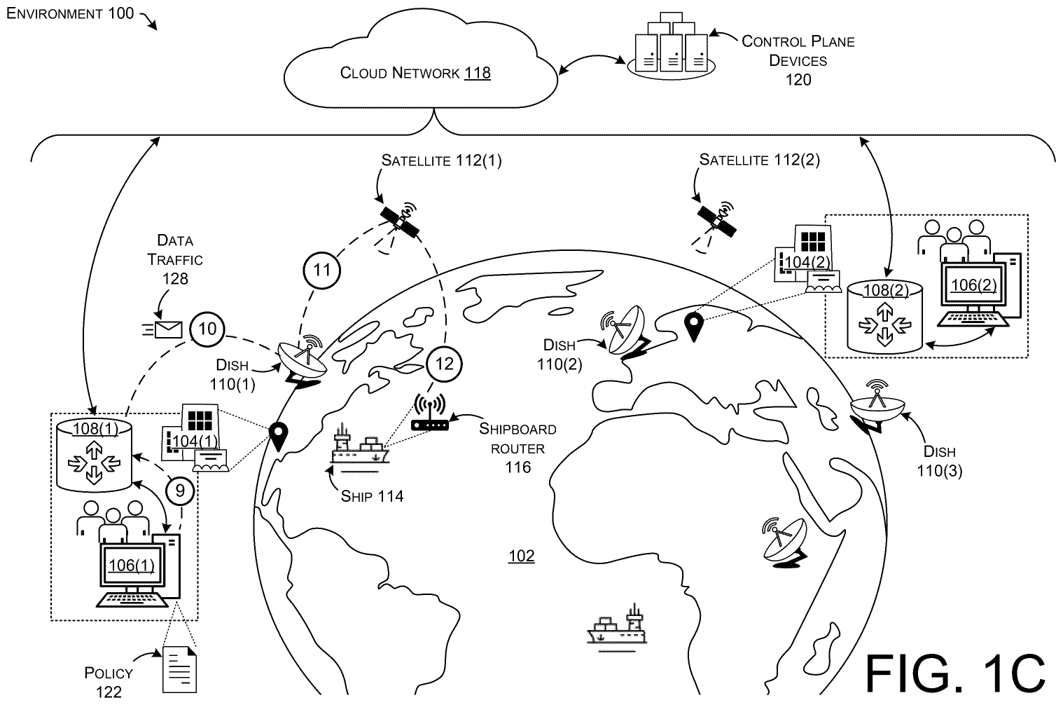

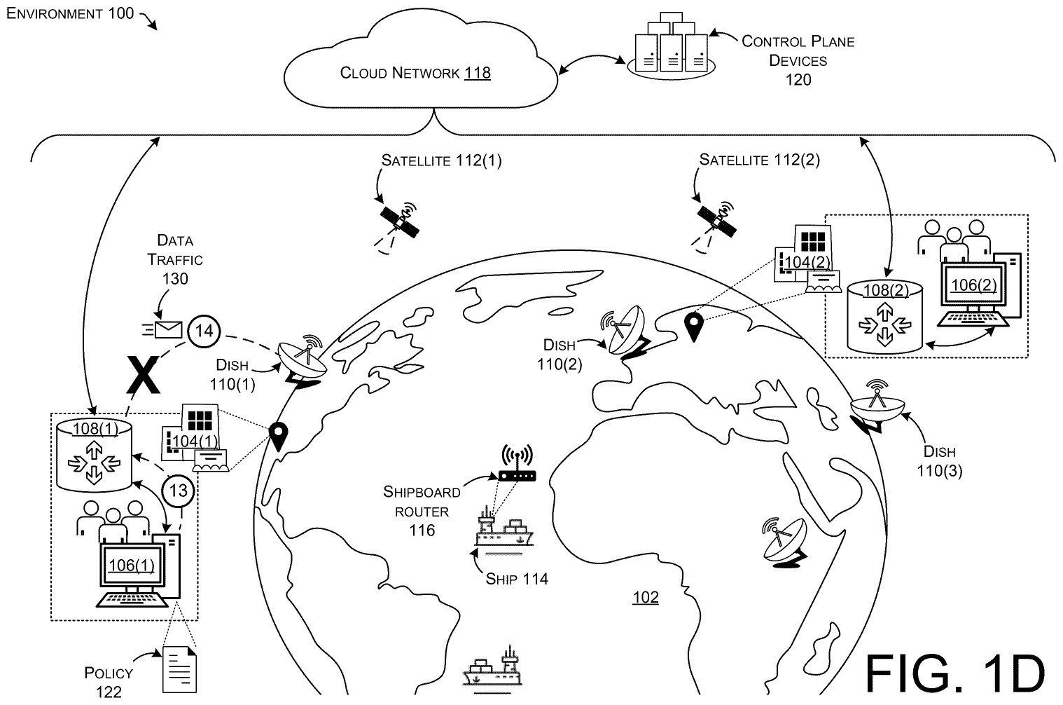

FIGS. 1A-1D collectively illustrate an example environment 100 in accordance with the present data traffic sovereignty protection concepts. FIGS. 1A-ID generally depict the Earth 102. Example environment 100 may include locations 104 on Earth. The locations 104 (e.g., building, campus, branch, remote site, office, etc.) may be associated with an organization, government, or other entity. The locations 104 may include one or more user devices 106 (e.g., computer, laptop, mobile device, tablet, etc.) and one or more routers 108, indicated by a dashed line. In some cases, parentheticals are utilized after a reference number to distinguish like elements. Use of the reference number without the associated parenthetical is generic to the element. For instance, in FIG. 1A, two locations 104 are depicted, including location 104(1) and location 104(2). The number of elements depicted is not meant to be limiting; any number of locations 104, user devices 106, routers 108, or other elements are contemplated. The various elements illustrated in FIGS. 1A-1D, including the representation of the Earth, are not to scale.

Example environment 100 may also include one or more satellite dishes 110, satellites 112, ships 114, and shipboard routers 116. The satellites 112 and ships 114 may be viewed as mobile elements that may travel to different geographic locations with respect to the Earth 102. For example, the satellites 112 (e.g., low Earth orbit (LEO) satellites) may be moving in orbit around the Earth such that the distance between any satellite 112 and any location 104 changes over time. Also, the particular satellite dish 110 that a satellite 112 may be able to communicate with may change over time, depending on the proximity of the satellite 112 to the satellite dish 110, or another factor, such as line-of-sight between the satellite 112 and the satellite dish 110. In this manner, a satellite 112 may be viewed as a mobile router (e.g., mobile network device), with a changing geographic location, and therefore changing how it might be incorporated into a network topology. Similarly, a shipboard router 116 may travel on the ship 114 to different geographic locations with respect to the Earth 102, across oceans or other waterways. Other examples of mobile routers are contemplated, such as a router on an airplane, unmanned aerial vehicle (UAV), truck, or other type of vehicle.

Example environment 100 may also include a cloud network 118, which may feature control plane devices 120 (e.g., controller devices, controllers) and other network devices. Any of the devices of environment 100 may be communicatively coupled to various other devices of environment 100 via network connection(s). For instance, the cloud network 118 and/or control plane devices 120 may be accessible to routers 108, satellite dishes 110, etc., as indicated by a bracket. Various subdivisions of the overall network are contemplated. In some examples, the user devices 106 and routers 108 at locations 104 may be considered part of a local area network, or a software defined wide area network (SD-WAN). The network may be further extended by being able to access cloud network 118 (depicted as double arrow extending from router 108(1) to the bracket, for instance). The cloud network 118 may be viewed as providing access to the control plane devices 120. Within the example environment 100, any of the devices (e.g., routers 108, satellite dishes 110, etc.) may exchange communications (e.g., packets) via network connection(s). For instance, the network connections may be transport control protocol (TCP) network connections or any network connection (e.g., information-centric networking (ICN)) that enable the network devices to exchange packets with other devices via the network connections. The network connections represent, for example, data paths between the devices of environment 100. It should be appreciated that the term “network connection” may also be referred to as a “network path.” The use of a cloud computing network 118 in this example is not meant to be limiting. Other types of networks are contemplated in accordance with data traffic sovereignty protection concepts, such as an enterprise system.

FIGS. 1A and 1B depict a first example data traffic sovereignty protection scenario involving movement of satellites 112. FIGS. 1C and 1D depict a second example data traffic sovereignty protection scenario involving the movement of a ship 114. The example scenarios may involve a sovereignty policy 122. The sovereignty policy 122 may be held by user device 106(1). The sovereignty policy 122 may describe geographic locations to which or through which data traffic should not be sent. For instance, the sovereignty policy 122 may specify one or more geographic boundaries (Geo-Boundaries) that are approved for data traffic, and/or may specify one or more Geo-Boundaries that are not approved for data traffic. The scenarios include examples of communications between various devices of environment 100. The communications are indicated with dashed, numbered lines. For example, referring to FIG. 1A, at “Step 1,” user device 106(1) may wish to initiate the movement of data traffic 124 from user device 106(1) to another device in environment 100. For example, an intended destination for data traffic 124 may be user device 106(2). In Step 1, the data traffic may move from user device 106(1) to router 108(1).

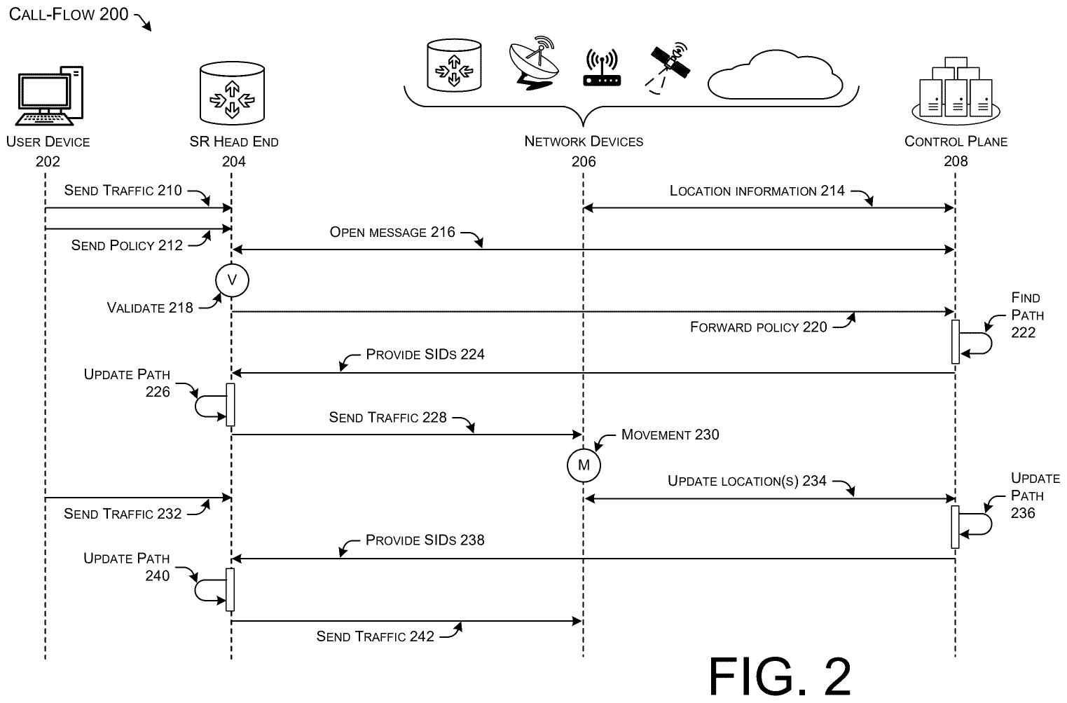

At “Step 2” of FIG. 1A, router 108(1) may forward the data traffic 124 to satellite dish 110(1). Note that the data traffic may travel through additional devices en route to satellite dish 110(1), including through the cloud network 118 and/or other devices that are not shown in FIG. 1A. Furthermore, data traffic 124 may be subject to sovereignty policy 122. For example, data traffic 124 may contain sensitive information that the user wishes to keep secure. Router 108(1) may forward data traffic 124 to satellite dish 110(1) after a determination that a geographic location of satellite dish 110(1) complies with sovereignty policy 122. The compliance determination may be made by one or more of the control plane devices 120, for instance. In some examples, the control plane device(s) 120 may determine a path for the data traffic 124 that complies with sovereignty policy 122. For example, the control plane device(s) 120 may include a PCE controller. The path determination may be made through communication of the sovereignty policy 122 from the user device 106(1) to the control plane device(s) 120, for instance. Example communications between devices of environment 100 will be described in greater detail relative to FIG. 2, below.

At “Step 3” of FIG. 1A, satellite dish 110(1) may forward the data traffic 124 to satellite 112(1). At “Step 4” of FIG. 1A, satellite 112(1) may forward the data traffic 124 to satellite dish 110(2). At “Step 5” of FIG. 1A, satellite dish 110(2) may forward the data traffic 124 to router 108(2), which may then forward the data traffic 124 to user device 106(2).

In FIG. 1B, satellites 112(1) and 112(2) have changed position relative FIG. 1A. In FIG. 1A, the current geographic location of satellite 112(1) is shown relatively close to (above) the geographic location of both satellite dishes 110(1) and 110(2). In FIG. 1B, some time has lapsed since the instance shown in FIG. 1A, and now the current geographic location of satellite 112(2) is still relatively close to the geographic location of satellite dish 110(2), but no longer close to the geographic location of satellite dish 110(1). Further, the current geographic location of satellite 112(1) in FIG. 1B is now also relatively close to the geographic location of satellite dish 110(3). However, satellite dish 110(3) may be located in an area that is not compliant with sovereignty policy 122. In this example scenario, there may be concerns about using satellite 112(1) when it is located as shown in FIG. 1B, since a new instance of data traffic 126 sent through satellite 112(1) may be forwarded to and/or intercepted by satellite dish 110(3). Arrival of data traffic 126 at satellite dish 110(3) could be associated with a security breach. Therefore, control plane device(s) 120 may wish to prevent data traffic 126 from being sent to satellite 112(1) until its geographic location returns to a compliant area.

As such, at “Step 6” of FIG. 1B, data traffic 126 may pass from user device 106(1) to router 108(1). At “Step 7” of FIG. 1B, data traffic 126 may pass from router 108(1) to satellite dish 110(1). At “Step 8” of FIG. 1B, data traffic 126 may be prevented from going to satellite 112(1), represented by an “X”. Stated another way, satellite 112(1) may be excluded from a data path for data traffic 126. Instead, data traffic 126 may be sent by a different route to user device 106(2), such as through satellite 112(2) (not shown).

As noted above, FIGS. 1C and 1D depict a second example data traffic sovereignty protection scenario involving the movement of a ship 114 in environment 100. In this scenario, a user may wish to send an instance of data traffic 128 from user device 106(1) to a device aboard ship 114. For example, referring to FIG. 1C, at “Step 9,” the data traffic 128 may move from user device 106(1) to router 108(1).

At “Step 10” of FIG. 1C, router 108(1) may forward the data traffic 128 to satellite dish 110(1). The data traffic 128 may be subject to sovereignty policy 122. Router 108(1) may forward the data traffic 128 to satellite dish 110(1) after a determination that a geographic location of satellite dish 110(1) complies with sovereignty policy 122. The compliance determination may be made by one or more of the control plane devices 120, for instance. In some examples, the control plane device(s) 120 may determine a path for the data traffic 128 that complies with sovereignty policy 122. The path determination may be made through communication of sovereignty policy 122 from the user device 106(1) to the control plane device(s) 120, for instance.

At “Step 11” of FIG. 1C, satellite dish 110(1) may forward the data traffic 128 to satellite 112(1). At “Step 12” of FIG. 1C, satellite 112(1) may forward the data traffic 128 to shipboard router 116. In this scenario, the control plane device(s) 120 may have known a relatively current geographic location of both satellite 112(1) and shipboard router 116 in order to determine a path for data traffic 128. Stated another way, control plane device(s) 120 may have validated that a geographic location of shipboard router 116 complied with sovereignty policy 122 allowing shipboard router 116 to receive the data traffic 128, and may also have validated that the current geographic location of satellite 112(1) allowed it to be included in a path for data traffic 128 to reach shipboard router 116.

In FIG. 1D, ship 114 has changed position relative FIG. 1C. In FIG. 1C, the current geographic location of ship 114 was shown relatively close to the east coast of the North American continent. In FIG. 1D, some time has lapsed since the instance shown in FIG. 1C, and now the current geographic location of ship 114 is closer to the continents of Africa and South America than to North America. The geographic location of ship 114 may represent an area that does not comply with sovereignty policy 122, or an area in which it is unclear whose sovereignty, or laws, would apply. Stated another way, the ship 114 may be outside of a Geo-Boundary that is compliant with the sovereignty policy 122, or the ship 114 may be within a Geo-Boundary that is not compliant with the sovereignty policy 122. In this example scenario, there may be security concerns about sending a new instance of data traffic 130 to shipboard router 116. Therefore, control plane device(s) 120 may wish to prevent data traffic 130 from being sent to shipboard router 116 until its geographic location is determined to be within a compliant area.

As such, at “Step 13” of FIG. 1D, data traffic 130 may pass from user device 106(1) to router 108(1). However, at “Step 14” of FIG. 1D, data traffic 130 may be prevented from going to satellite dish 110(1), represented by an “X”. In this scenario, the data traffic 130 may not be sent to shipboard router 116 until the ship 114 has moved to a different geographic location that complies with the sovereignty policy 122. Therefore, the data traffic 130 may not go further than router 108(1) until the control plane device(s) 120 finds a secure path to a secure geographic location per the sovereignty policy 122.

FIG. 2 illustrates an example call-flow 200 in accordance with the present data traffic sovereignty protection concepts. The example call flow may be representative of communications between devices similar to some of the communications described relative to FIGS. 1A-1D between the devices of environment 100. Some aspects of the example elements shown in FIG. 2 may be similar to aspects of the examples described above relative to FIGS. 1A-1D. Therefore, for sake of brevity, not all elements of FIG. 2 will be described in detail.

The example call-flow 200 includes communications between a user device 202, a segment routing (SR) head end device 204, one or more network devices 206, and one or more devices of a control plane 208. The user device 202 may be similar to user device 106(1) depicted in FIGS. 1A-ID. Also, SR head end device 204 may be similar to router 108(1), control plane 208 may be similar to one or more of control plane devices 120, and network devices 206 may be similar to any of various mobile and/or stationary devices of environment 100, such as routers 108, satellite dishes 110, satellites 112, shipboard router 116, a device of cloud network 118, etc. It should also be appreciated that more or fewer communications might be performed than shown in FIG. 2 and described herein. At least some of these communications may also be performed in parallel, or in a different order than those described herein. Some or all of these communications may also be performed by components other than those specifically identified.

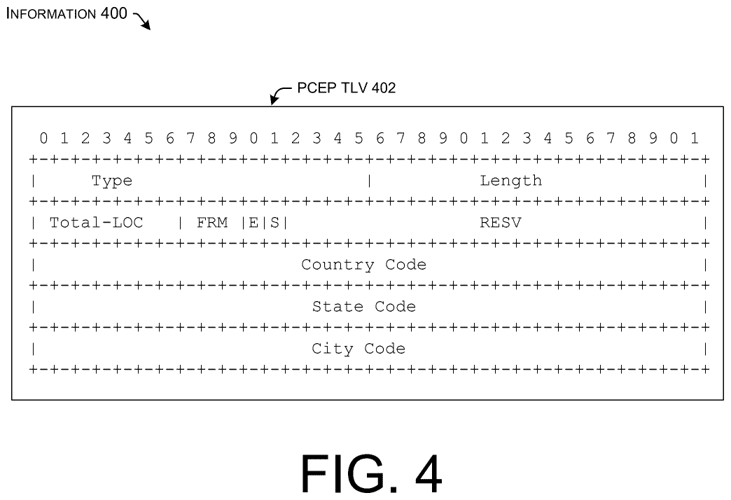

In example call-flow 200, at 210 user device 202 may send data traffic to SR head end device 204. This may include initiating a data traffic flow, sending data packets to the SR head end device 204, stating the intended destination and/or recipient of the data traffic, etc. At 212, the user device 202 may send a sovereignty policy to the SR head end device 204. The sovereignty policy may apply to the data traffic. The sovereignty policy may include sovereignty restrictions as one of its constraints. In some examples, the sovereignty policy may be a Data Sovereignty Protection Intent (DSPI). In some examples, the SR head end device 204 may create a sovereignty policy based on input from the user and/or based on knowledge of the source and/or destination. Note that the sovereignty policy may be sent to or created by the SR head end device 204 before the data traffic flow is initiated. The DSPI may be provided via a path computation element protocol (PCEP) interface or PCEP message, for instance (described in more detail below, relative to FIG. 4).

At 214, control plane 208 may be communicating with network devices 206 to exchange geographic location information. The exchange of geographic location information may be automatic, ongoing, continuous, and/or intermittent. The exchange of geographic location information may also be triggered by an event, such as by control plane 208 receiving a request for a data path or determining a change in location of a mobile router, and/or with the passage of a predetermined time interval. Additionally or alternatively, the geographic location information may be updated when the change in location of a network device 206 crosses a Geo-Boundary border, or when the location change is greater than a certain threshold (e.g., a measure of distance), for example.

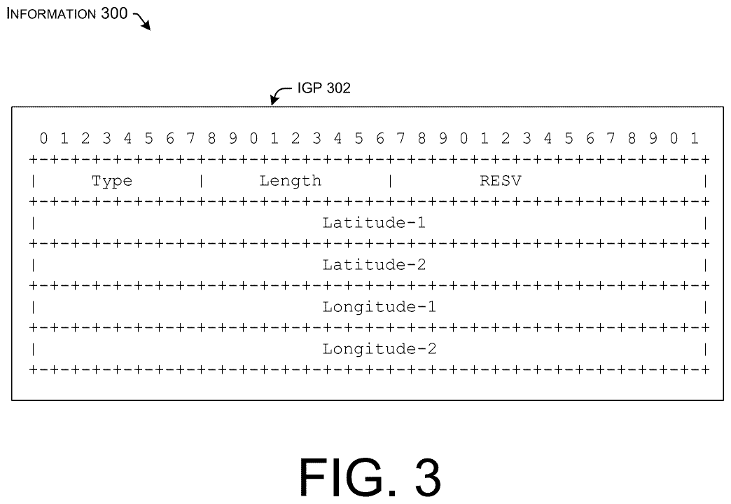

At 214, the geographic location information received in the control plane 208 may come from the network device 206 itself or from another source of geographic location information. For instance, the geographic location information may be distributed through a data source such as interior gateway protocol (IGP), or border gateway protocol with link state (BGP-LS). In some examples, the one or more devices at the control plane 208 may include one or more path computation element (PCE) controllers. One PCE controller may interact with another controller that has a particular capability regarding geographic location determination (e.g., a geolocation controller) to get more precise information about the network devices (e.g., nodes). A geolocation controller may evaluate and/or authenticate geographic location(s) of network devices, for instance. In some implementations, a PCE controller may determine a geographic location of a network device from an interior gateway protocol (IGP) Geolocation Link state attribute, or internet protocol (IP), or another geolocation service. FIG. 3 illustrates an example of geographic location information 300. In this example, IGP 302 carries the geographic location of a network device (e.g., latitude and longitude) using a Link-state Type/Length/Value (TLV) format.

Other examples of the control plane 208 receiving geographic location information about a network device 206 are contemplated. For instance, a Sub-TLV may be added to an intermediate system-to-intermediate system (IS-IS) or open shortest path first (OSPF) traffic engineering (TE) extension to carry the geographic location metric of a network device (e.g., latitude and longitude). The information may be advertised to other nodes and to the PCE via BGP-LS, in some examples. In another example of determining geographic location information, network devices can obtain their geographic location using various methods such as by global positioning system (GPS), manual configuration, IP address lookup, network topology information, etc. In some implementations, the introduction of Low Earth Orbit (LEO) satellites may enable the detection of locations of connected base stations on Earth. Route topology exchanged with the LEO satellites may help approximate the geographic locations of devices based on Interior Gateway Protocol (IGP) hop counts. The approximate geographic locations may be sent to the Geo-Location controller. Similarly, multiple LEO satellites may learn about topology and exchange information with the Geo-Location controller. Using this information, the Geo-Location controller may employ artificial intelligence (AI) to predict the geographic location of each device. In yet another example, a mobile device could update its geographic location based on a relationship with allies. For instance, if a war ship or LEO satellite has a partnership with two different countries, then the mobile device could update its geographic location metric only when it is within a Geo-Boundary of a country/state with which it is an ally.

Referring again to FIG. 2, at 216, the SR head end 204 may send an open message (e.g., request for comments (RFC) 5440) to the control plane 208 to begin the process of arranging a data path for the data traffic from the user device 202 to the intended destination. The open message may include, or be viewed as, a request for a data path (e.g., path computation request). The open message may include multiple back-and-forth messages between the SR head end device 204 and the control plane 208. Further, the message(s) may include communications with more than one device at control plane 208. The open message may include establishing communication with a specific PCE controller. The SR head end device 204 may be viewed as a path computation client (PCC), in this instance. In some examples, an optional TLV may be added to a message to the PCC that includes a geographic location of the PCE. For instance, based on the traffic-engineering configuration, the PCC may initiate communication with a particular PCE. The PCE to whom the PCC has initiated communication may then send the TLV that includes geographic location information of the PCE.

At 218, the SR head end 204 may validate the connection, which may include validating that a location of the PCE controller is compliant with the sovereignty policy. The PCC may now validate the PCE against a Geo-Boundary in the DSPI policy to determine whether to delegate path computation to that PCE. Checking the location of the PCE allows selection of a PCE based on specific policy configurations; thus, the same PCE might be accepted for one policy on a device, but not for another policy relevant to a different data traffic flow from the same device.

Once the SR head end device 204 has opened and/or validated communications with the control plane 208, at 220 SR head end device 204 may forward the sovereignty policy to the control plane 208. In some examples, a PCE controller at the control plane 208 may receive the DSPI using a PCEP message and/or PCEP interface. For instance, a PCEP TLV may be used to convey the intent of sovereignty restrictions.

FIG. 4 illustrates an example of sovereignty policy information 400. In this example, a PCEP Sub-TLV 402 carries DSPI information to the PCE controller. The DSPI may be carried in a new extension to an existing PCEP Sub-TLV, for instance. In the example PCEP TLV 402 shown in FIG. 4, “Total-Loc” may refer to a total number of locations encoded. “FRM” may refer to a three bits Geo-Boundary encoding format. In this format, “0” may indicate using a generic method, where the Country code is 4 bytes, the Province/State is 4 bytes, and the City Code 4 bytes, for example, and a value “0” may represent a wildcard. “1” may indicate using a Geo-Fence Location Method, such as using Central Latitude (4 bytes), Central Longitude (4 bytes), and Radius in meters (4 bytes). “2-7” may be reserved. In the example PCEP TLV 402, “E” may indicate whether the policy intends to include or exclude the encoded Geo-Fence. For instance, a value of “0” may include all of the encoded Geo-Boundary, while a value of “1” may exclude all of the encoded Geo-Boundary. In the example PCEP TLV 402, “S” may indicate a Strict Bit. For example, if this bit is set, then the policy dictates strict adherence to including or excluding the defined Geo-Boundary. In an instance where a potential path fails to comply with this rule, then the operation must be set to a down state. Alternatively, if this bit is not set, then the policy dictates that the encoded Geo-Boundary should be included or excluded based on a best-effort basis. If a potential path does not fully match this rule, the operation may remain UP and follow the closest matching rule available. In the example PCEP TLV 402, “RESV” indicates bits reserved for future use.

Referring again to FIG. 2, at 222, the control plane 208 may determine a path for the data traffic. The control plane 208 may use the geographic location and/or the sovereignty policy to compute the path for the data traffic. For example, the control plane 208 may consider the geographic location(s) of network device(s) that are potential candidates for the path to ensure the path is compliant with the sovereignty policy. As noted above, the control plane 208 may use multiple sources of geographic location to establish or verify the geographic location of a network device 206. In addition to establishing a geographic location so that it may be checked against a Geo-Boundary in a DSPI, for instance, verification of a geographic location may be helpful to prevent spoofing of a geographic location of a network device 206. The PCE controller may interact with a geolocation controller(s) to get more precise information about the DSPI, as well.

In some examples, a metric may be used to indicate a confidence level in how well a geographic location is believed to comply with a sovereignty policy. The metric may be termed a Sovereignty Authenticity Index (SAI), for instance. An SAI value may indicate confidence in a geographic location of a network device 206, confidence that the geographic location is within a Geo-Boundary, confidence that a Geo-Boundary is based on a current (e.g., up-to-date) sovereignty policy, etc. For instance, if a geographic location of a mobile network device 206 is determined to be relatively close to a border of a Geo-Boundary, a lower confidence value (e.g., lower SAI value) may be assigned to the network device 206, indicating concern that the network device 206 may cross into an unapproved area. In another instance, a lower SAI value may be assigned to a network device 206 where the source of geographic location information for the network device 206 is less trusted, or the geographic location information is unverified by a more trusted source. In a scenario where there is a need for a tiebreaker between network devices 206 that are being considered for a data traffic flow path, the SAI may be used to select the network device 206 that better complies with the sovereignty policy. In other examples, there may be a threshold SAI value to accepting and/or trusting the geographic location of a network device. For instance, the SAI value of a network device 206 could be used as an input to the PCE controller to eliminate that network device 206 if the SAI is too low, or if the SAI is below a predetermined threshold for a particular path calculation.

Additional inputs to the PCE controller(s) for use in determining data traffic paths are contemplated. In some examples, inputs could include time (e.g., a time limit for the data traffic, delivery time, current time), a Geo-Boundary associated with the sending or receiving devices (or other network devices), a number of active head end devices, additional or total dynamic/static DSPI policies, the Geo-Boundary constraints of additional DSPI policies, etc. The PCE controller(s) may use artificial intelligence and/or machine learning (AI/ML) to predict a need for a dedicated topology for a specific Geo-Boundary, create a separate topology for a specific Geo-Boundary, and/or apply multiple DSPI policy constraints. In some examples, based on a DSPI policy load, the PCE controller(s) could create a separate topology that includes only the devices with geographic locations that are specified within the DSPI policy. Additionally, other types of policy constraints (e.g., cost, resource expense, bandwidth, latency, etc.) could be applied along with the Geo-Boundary type constraints. Furthermore, in some examples multiple PCE controllers could negotiate among themselves. Based on the policies, the PCE controllers could delegate a PCEP request to a matching DSPI PCE controller. Stated another way, a PCEP request could be sent to a PCE controller with specific capabilities or bandwidth to handle a DSPI routing determination. The various controllers could apply any of a variety of policy constraints on top of the DSPI-specific concerns before returning the request back to the source (e.g., a head end device).

At 224, the control plane may provide instructions to the SR head end 204 for routing the data traffic from user device 202 to the intended destination. The instructions may include one or more segment identifiers (SIDs), for instance. At 226, the SR head end 204 may receive the instructions and incorporate them into a path for the data traffic. At 228, the data traffic may be sent toward the intended destination, via one or more of the network devices 206, based on the instructions received from the control plane 208.

Meanwhile, there may have been movement among the network devices 206, indicated at 230. For example, a geographic location of a network device 206 may have changed. A location change may include a satellite moving through orbit, a vehicle moving to a new location, or a device that is typically stationary being installed in a new location, for instance.

At 232, the user device 202 may wish to send subsequent data traffic, which may be part of a continuing data traffic flow or a new data traffic flow. At 234 the control plane 208 may be communicating with the one or more network devices 206 to update location information as necessary. Here again, the location information may be updated automatically, continually, intermittently, or in response to some triggering event or threshold reached. The update at 234 may also refer to confirming that a location of a network device has not changed and/or is still within a compliant area with respect to a sovereignty policy.

At 236 the control plane 208 may use the updated location information to update a path for the data traffic, if indicated. At 238, updated route information or instructions, such as SIDs, may be sent to the SR head end device 204. At 240, the SR head end device 204 may use the updated route information to establish a path for the data traffic. At 242, the data traffic may be sent via the updated path.

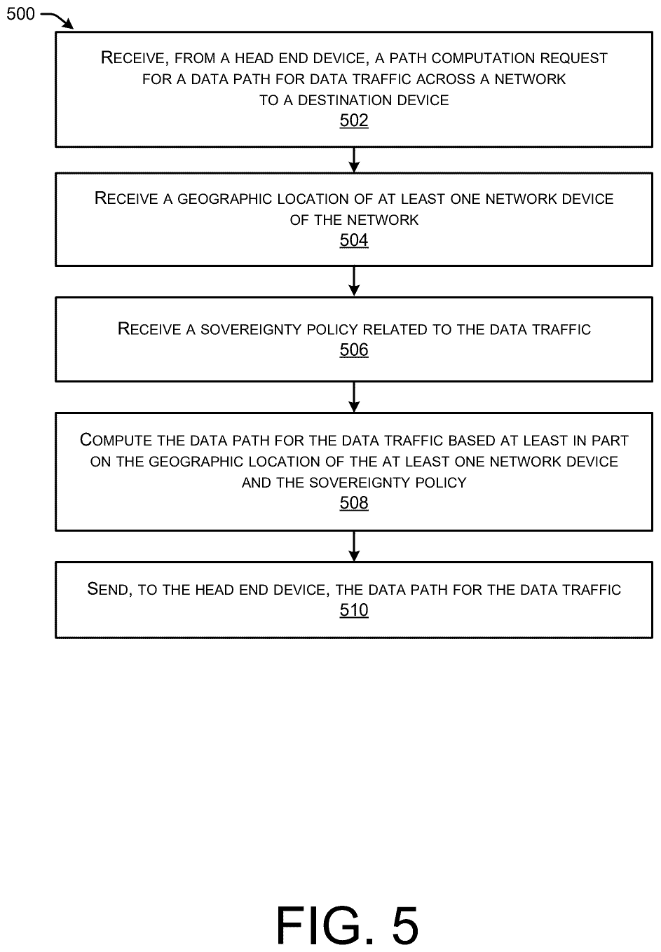

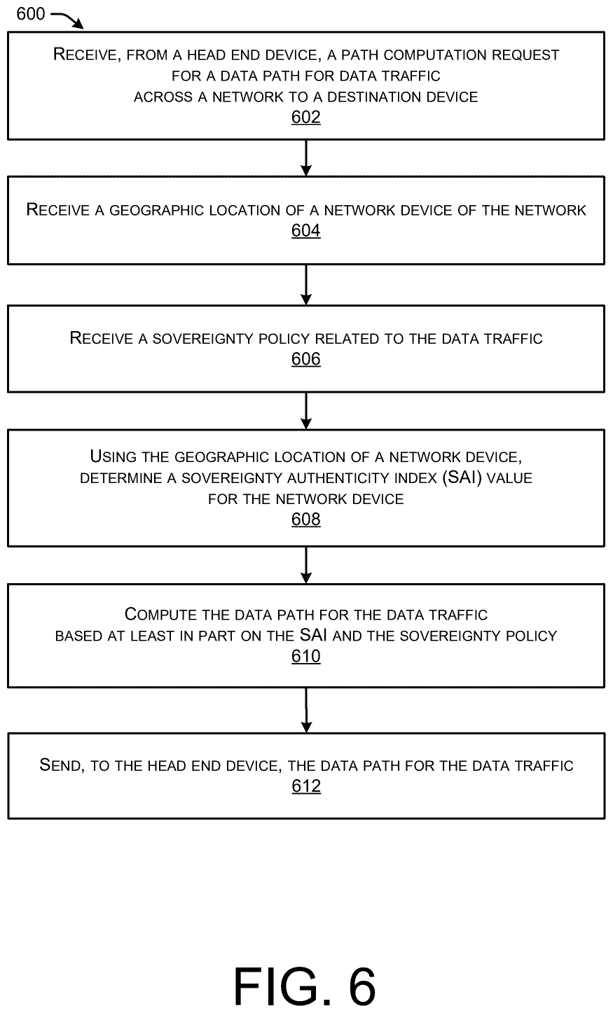

FIGS. 5 and 6 illustrate flow diagrams of example methods 500 and 600 that include functions that may be performed at least partly by a control plane device, such as control plane devices 120 or a device of control plane 208, and/or a network device, such as routers 108 or 204 or network devices 206, described relative to FIGS. 1A-2. The logical operations described herein with respect to FIGS. 5 and 6 may be implemented (1) as a sequence of computer-implemented acts or program modules running on a computing system and/or (2) as interconnected machine logic circuits or circuit modules within the computing system. In some examples, the method(s) 500 and/or 600 may be performed by a system comprising one or more processors and one or more non-transitory computer-readable media storing computer-executable instructions that, when executed by the one or more processors, cause the one or more processors to perform the method(s) 500 or 600.

The implementation of the various devices and/or components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 5 and 6 and described herein. These operations may also be performed in parallel, or in a different order than those described herein. Some or all of these operations may also be performed by components other than those specifically identified. Although the techniques described in this disclosure is with reference to specific devices, in other examples, the techniques may be implemented by less devices, more devices, different devices, or any configuration of devices and/or components.

FIG. 5 illustrates a flow diagram of an example method 500 for network devices to perform data traffic sovereignty protection techniques. Method 500 may be performed by a controller device (e.g., control plane device 120, a device of control plane 208) communicatively coupled to a head end device (e.g., head end device 204, router 108) and one or more network devices (e.g., network device 206), for instance.

At 502, method 500 may include receiving a path computation request for a data path. The request may be received at the controller device and received from a head end device. The data path may be intended for data traffic that a user device wishes to send via the head end device, across a network, to a destination device. In some examples, the controller device may be a segment routing-path computation element (SR-PCE) controller.

At 504, method 500 may include receiving a geographic location of at least one network device of the network. The geographic location of the network device may be received in a Link state Type/Length/Value (TLV) format. The geographic location may be received from the network device itself. Multiple instances of the geographic location may be received from multiple sources. In some examples, the controller device may determine the geographic location by compiling geographic location information from multiple sources. For instance, the controller device may assign a higher weight or confidence to geographic location information obtained from relatively more trusted sources. In this manner, the controller device may make a determination in a confidence level of the actual geographic location of the network device. Furthermore, the network device may be a mobile network device, where the geographic location of the network device may change over time. In this case, the geographic location may be updated.

At 506, method 500 may include receiving a sovereignty policy related to the data traffic. In some examples, the sovereignty policy may be a Data Sovereignty Protection Intent (DSPI) policy. The sovereignty policy may be received in a Path Computation Element Protocol (PCEP) Sub-Type/Length/Value (Sub-TLV) message, for instance. The sovereignty policy may contain information regarding approved or unapproved geographic areas. For instance, the sovereignty policy may specify a Geo-Boundary that the data traffic is to remain within, or the sovereignty policy may specify a Geo-Boundary that the data traffic is to avoid.

At 508, method 500 may include computing the data path for the data traffic. The data path may be computed based at least in part on the geographic location of the network device and/or the sovereignty policy. In some examples, the path computation may include determining that the geographic location of the network device complies with the sovereignty policy. In an instance where the geographic location of the network device complies with the sovereignty policy, the network device may be included in the data path. For example, the geographic location of the network device may be located within a Geo-Boundary that is designated as an approved territory in the sovereignty policy, and therefore the geographic location of the network device may be compliant with the sovereignty policy. In other examples, the geographic location of the network device may be found to not comply with the sovereignty policy. In these examples, the network device may be excluded from the data path. The controller device may also determine an updated data path for the data traffic based at least in part on an updated geographic location of a network device.

At 510, method 500 may include sending the data path for the data traffic to the head end device. The method may also include sending an updated data path for the data traffic, which may be accompanied by instructions to preferentially use the updated data path, and/or instructions to desist using the previous data path.

FIG. 6 illustrates a flow diagram of an example method 600 for network devices to perform data traffic sovereignty protection techniques. Method 600 may be performed by a control plane device (e.g., a device of control plane 208) communicatively coupled to a network device (e.g., network device 206), for instance.

At 602, method 600 may include receiving, at the controller device and from a head end device, a path computation request for a data path. The data path may correspond to data traffic that is waiting to be sent across a network to a destination device.

At 604, method 600 may include receiving a geographic location of a network device of the network. In some examples, the network device may be considered a mobile network device, where the geographic location of the network device may change over time. In these examples, the geographic location of the network device may need to be updated over time.

At 606, method 600 may include receiving a sovereignty policy related to the data traffic. The sovereignty policy may be received from the head end device. The sovereignty policy may define constraints regarding where the data traffic may travel or not travel.

At 608, using the geographic location of the network device, method 600 may include determining a sovereignty authenticity index (SAI) value for the network device (and/or for the geographic location of the network device). In some examples, the SAI value may indicate whether the geographic location of the network device complies with the sovereignty policy. For instance, the SAI value may provide a confidence level in how secure a data path that includes the network device will be with respect to the constraints of the sovereignty policy.

At 610, method 600 may include computing the data path for the data traffic. The path computation may be based at least in part on the sovereignty authenticity index (SAI) and/or the sovereignty policy. In an instance where the SAI value indicates that the geographic location of the network device complies with the sovereignty policy, the network device may be included in the data path. In another instance where the SAI value indicates that the geographic location of the network device does not comply with the sovereignty policy, the network device may be excluded from the data path. Method 600 may also include updating the data path in response to a changing location of the network device, or automatically with the passage of time. In some examples, an updated geographic location may be checked for compliance with the sovereignty policy. The data path may be recomputed from time to time, such as where the updated geographic location is found to be out of compliance with the sovereignty policy.

At 612, method 600 may include sending the data path for the data traffic to the head end device. Further, updated data paths may be sent as new geographical location information is obtained.

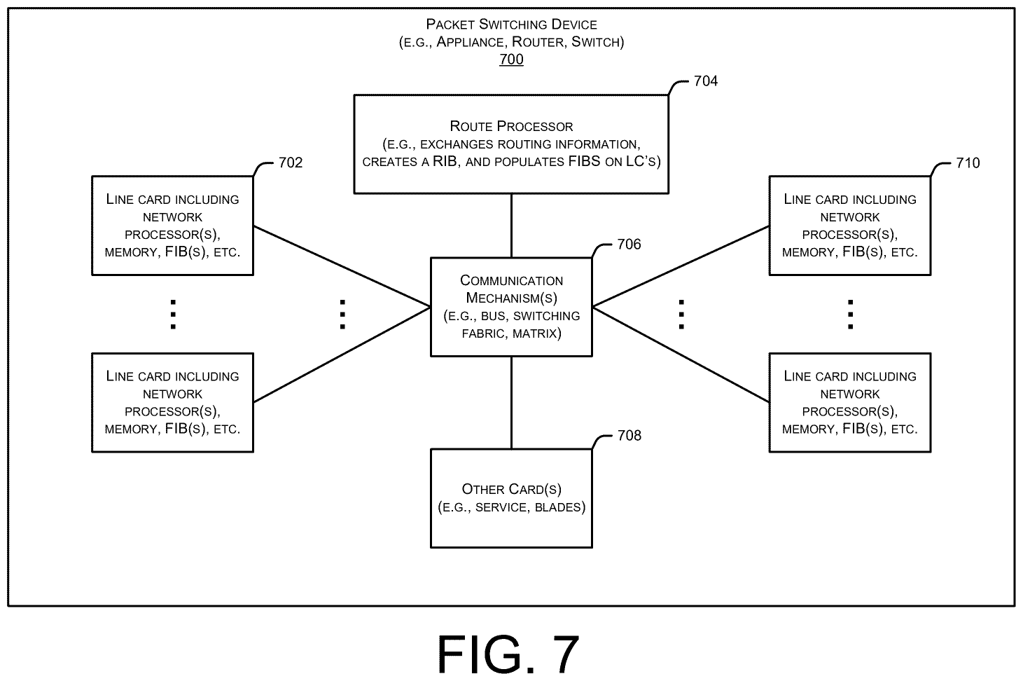

FIG. 7 illustrates a block diagram illustrating an example packet switching device (or system) 700 that can be utilized to implement various aspects of the technologies disclosed herein. In some examples, packet switching device(s) 700 may be employed in various networks, such as, for example, cloud network 118 as described with respect to FIGS. 1A-1D.

In some examples, a packet switching device 700 (e.g., packet switching system) may comprise multiple line card(s) 702, 710, each with one or more network interfaces for sending and receiving packets over communications links (e.g., possibly part of a link aggregation group). The packet switching device 700 may also have a control plane with one or more processing elements 704 for managing the control plane and/or control plane processing of packets associated with forwarding of packets in a network. The packet switching device 700 may also include other cards 708 (e.g., service cards, blades) which include processing elements that are used to process (e.g., forward/send, drop, manipulate, change, modify, receive, create, duplicate, apply a service) packets associated with forwarding of packets in a network. The packet switching device 700 may comprise hardware-based communication mechanism 706 (e.g., bus, switching fabric, and/or matrix, etc.) for allowing its different entities 702, 704, 708 and 710 to communicate. Line card(s) 702, 710 may typically perform the actions of being both an ingress and/or an egress line card 702, 710, in regard to multiple other particular packets and/or packet streams being received by, or sent from, packet switching device 700.

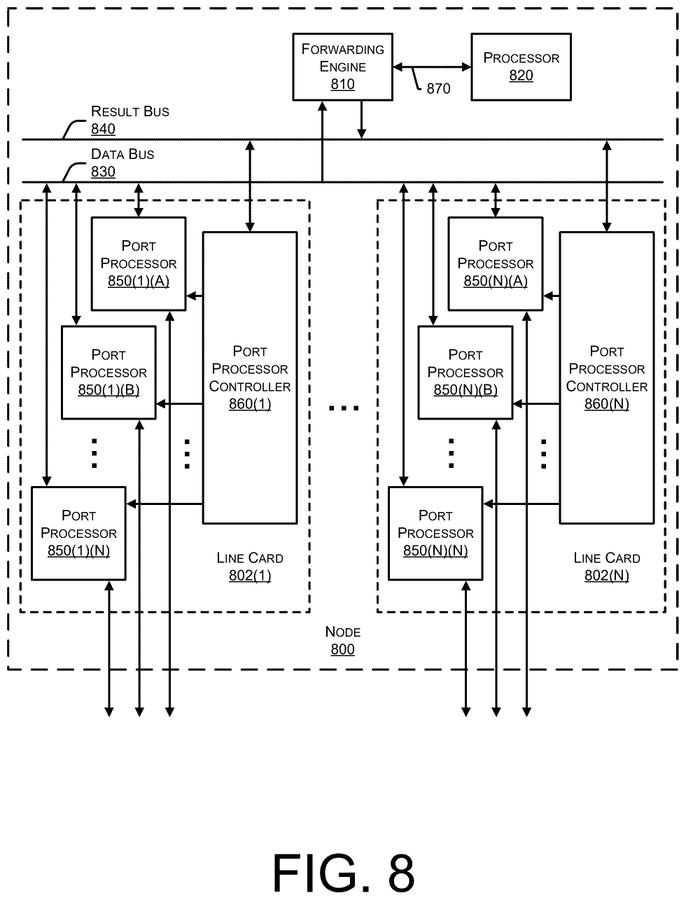

FIG. 8 illustrates a block diagram illustrating certain components of an example node 800 that can be utilized to implement various aspects of the technologies disclosed herein. In some examples, node(s) 800 may be similar to routers 108 shown in FIGS. 1A-1D, and/or may be employed in various networks, such as, for example, cloud network 118 as described with respect to FIGS. 1A-1D.

In some examples, node 800 may include any number of line cards 802 (e.g., line cards 802(1)-(N), where N may be any integer greater than 1) that are communicatively coupled to a forwarding engine 810 (also referred to as a packet forwarder) and/or a processor 820 via a data bus 830 and/or a result bus 840. Line cards 802(1)-(N) may include any number of port processors 850(1)(A)-(N)(N) which are controlled by port processor controllers 860(1)-(N), where N may be any integer greater than 1. Additionally, or alternatively, forwarding engine 810 and/or processor 820 are not only coupled to one another via the data bus 830 and the result bus 840, but may also communicatively coupled to one another by a communications link 870.

The processors (e.g., the port processor(s) 850 and/or the port processor controller(s) 860) of each line card 802 may be mounted on a single printed circuit board. When a packet or packet and header are received, the packet or packet and header may be identified and analyzed by node 800 (also referred to herein as a router) in the following manner. Upon receipt, a packet (or some or all of its control information) or packet and header may be sent from one of port processor(s) 850(1)(A)-(N)(N) at which the packet or packet and header was received and to one or more of those devices coupled to the data bus 830 (e.g., others of the port processor(s) 850(1)(A)-(N)(N), the forwarding engine 810 and/or the processor 820). Handling of the packet or packet and header may be determined, for example, by the forwarding engine 810. For example, the forwarding engine 810 may determine that the packet or packet and header should be forwarded to one or more of port processors 850(1)(A)-(N)(N). This may be accomplished by indicating to corresponding one(s) of port processor controllers 860(1)-(N) that the copy of the packet or packet and header held in the given one(s) of port processor(s) 850(1)(A)-(N)(N) should be forwarded to the appropriate one of port processor(s) 850(1)(A)-(N)(N). Additionally, or alternatively, once a packet or packet and header has been identified for processing, the forwarding engine 810, the processor 820, and/or the like may be used to process the packet or packet and header in some manner and/or maty add packet security information in order to secure the packet. On a node 800 sourcing such a packet or packet and header, this processing may include, for example, encryption of some or all of the packet's or packet and header's information, the addition of a digital signature, and/or some other information and/or processing capable of securing the packet or packet and header. On a node 800 receiving such a processed packet or packet and header, the corresponding process may be performed to recover or validate information of the packet and/or header that has been secured.

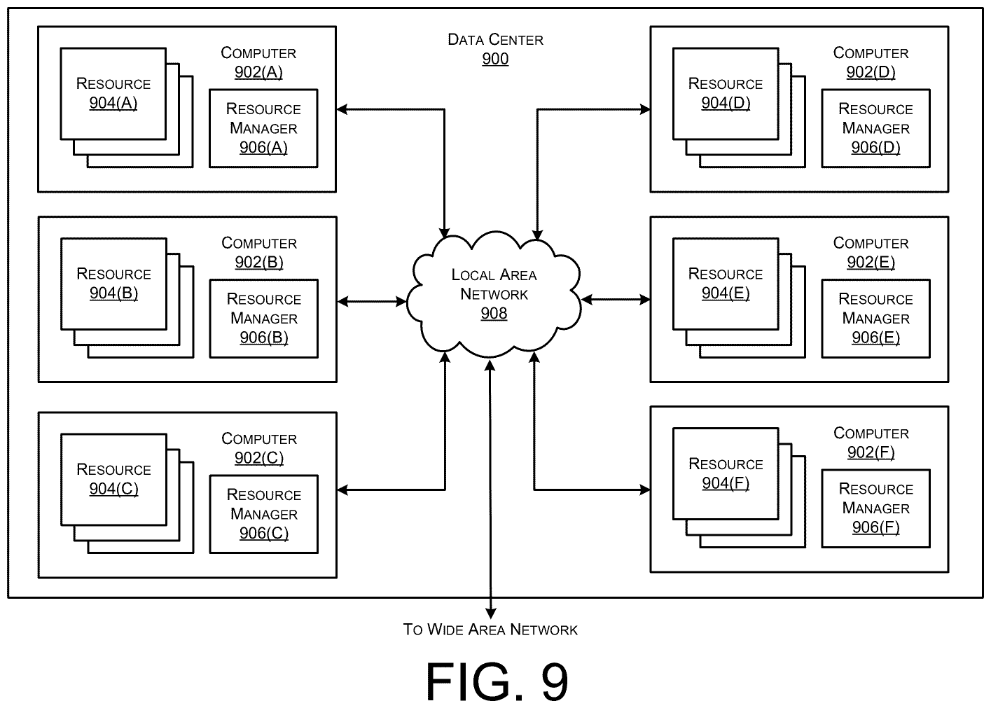

FIG. 9 is a computing system diagram illustrating a configuration for a data center 900 that can be utilized to implement aspects of the technologies disclosed herein. The example data center 900 shown in FIG. 9 includes several computers 902A-902F (which might be referred to herein singularly as “a computer 902” or in the plural as “the computers 902”) for providing computing resources. In some examples, the resources and/or computers 902 may include, or correspond to, any type of networked device described herein, such as user devices 106, routers 108, mobile devices, and/or any of network devices 206. Although, computers 902 may comprise any type of networked device, such as servers, switches, routers, hubs, bridges, gateways, modems, repeaters, access points, hosts, etc.

The computers 902 can be standard tower, rack-mount, or blade server computers configured appropriately for providing computing resources. In some examples, the computers 902 may provide computing resources 904 including data processing resources such as virtual machine (VM) instances or hardware computing systems, database clusters, computing clusters, storage clusters, data storage resources, database resources, networking resources, and others. Some of the computers 902 can also be configured to execute a resource manager 906 capable of instantiating and/or managing the computing resources. In the case of VM instances, for example, the resource manager 906 can be a hypervisor or another type of program configured to enable the execution of multiple VM instances on a single computer 902. Computers 902 in the data center 900 can also be configured to provide network services and other types of services.

In the example data center 900 shown in FIG. 9, an appropriate local area network (LAN) 908 is also utilized to interconnect the computers 902A-902F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 900, between each of the computers 902A-902F in each data center 900, and, potentially, between computing resources in each of the computers 902. It should be appreciated that the configuration of the data center 900 described with reference to FIG. 9 is merely illustrative and that other implementations can be utilized.

In some examples, the computers 902 may each execute one or more application containers and/or virtual machines to perform techniques described herein. For instance, the containers and/or virtual machines may serve as server devices, user devices, and/or routers in the cloud computing network 118.

In some instances, the data center 900 may provide computing resources, like application containers, VM instances, and storage, on a permanent or an as-needed basis. Among other types of functionality, the computing resources provided by a cloud computing network may be utilized to implement the various services and techniques described above. The computing resources 904 provided by the cloud computing network can include various types of computing resources, such as data processing resources like application containers and VM instances, data storage resources, networking resources, data communication resources, network services, and the like.

Each type of computing resource 904 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 904 not mentioned specifically herein.

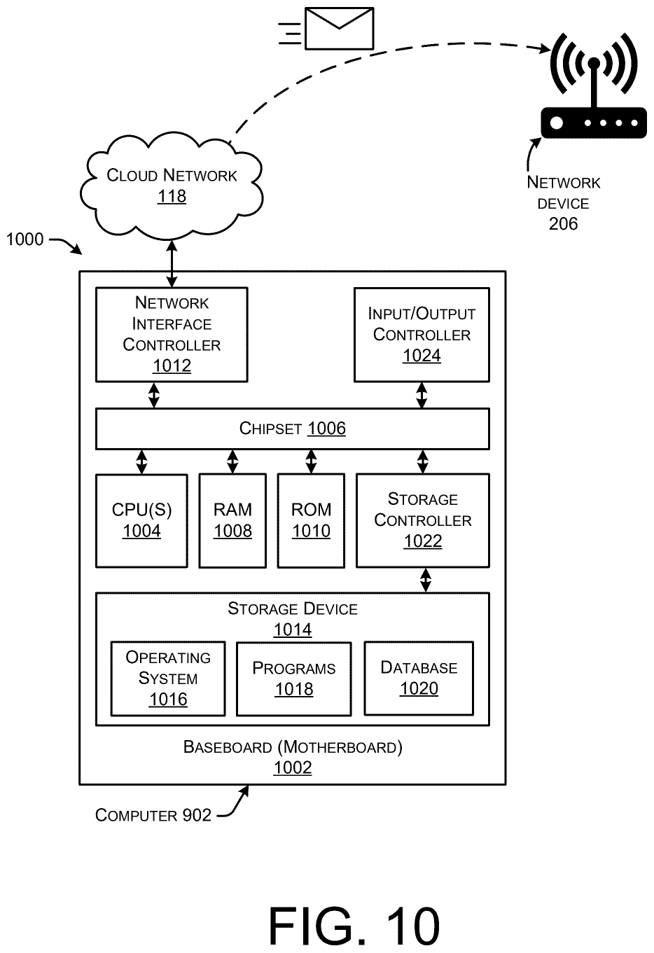

The computing resources 904 provided by a cloud computing network may be enabled in one embodiment by one or more data centers 900 (which might be referred to herein singularly as “a data center 900” or in the plural as “the data centers 900”). The data centers 900 are facilities utilized to house and operate computer systems and associated components. The data centers 900 typically include redundant and backup power, communications, cooling, and security systems. The data centers 900 can also be located in geographically disparate locations. One illustrative embodiment for a data center 900 that can be utilized to implement the technologies disclosed herein will be described below with regards to FIG. 10.

FIG. 10 shows an example computer architecture 1000 for a computer 902 capable of executing program components for implementing the functionality described above. The computer architecture 1000 shown in FIG. 10 illustrates a conventional server computer, workstation, desktop computer, laptop, tablet, network appliance, e-reader, smartphone, and/or other computing device, and can be utilized to execute any of the software components presented herein. The computer 902 may, in some examples, correspond to a physical device described herein (e.g., user device, network device, controller device, server device, etc.), and may comprise networked devices such as servers, switches, routers, hubs, bridges, gateways, modems, repeaters, access points, etc. For instance, computer 902 may correspond to any of control plane devices 120 or a device of control plane 208.

As shown in FIG. 10, the computer 902 includes a baseboard 1002, or “motherboard,” which is a printed circuit board to which a multitude of components or devices can be connected by way of a system bus or other electrical communication paths. In one illustrative configuration, one or more central processing units (“CPUs”) 1004 operate in conjunction with a chipset 1006. The CPUs 1004 can be standard programmable processors that perform arithmetic and logical operations necessary for the operation of the computer 902.

The CPUs 1004 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1006 provides an interface between the CPUs 1004 and the remainder of the components and devices on the baseboard 1002. The chipset 1006 can provide an interface to a RAM 1008, used as the main memory in the computer 902. The chipset 1006 can further provide an interface to a computer-readable storage medium such as a read-only memory (“ROM”) 1010 or non-volatile RAM (“NVRAM”) for storing basic routines that help to startup the computer 902 and to transfer information between the various components and devices. The ROM 1010 or NVRAM can also store other software components necessary for the operation of the computer 902 in accordance with the configurations described herein.

The computer 902 can operate in a networked environment using logical connections to remote computing devices and computer systems through a network, such as cloud network 118 or network 908, etc. The chipset 1006 can include functionality for providing network connectivity through a network interface controller (NIC) 1012, such as a gigabit Ethernet adapter. The NIC 1012 is capable of connecting the computer 902 to other computing devices over the network 118. For instance, in the example shown in FIG. 10, NIC 1012 may help facilitate transfer of data, packets, and/or communications (indicated by the envelope in FIG. 10) over the network 118 with a network device 206. It should be appreciated that multiple NICs 1012 can be present in the computer 902, connecting the computer to other types of networks and remote computer systems.

The computer 902 can be connected to a storage device 1014 that provides non-volatile storage for the computer. The storage device 1014 can store an operating system 1016, programs 1018, sovereignty policy 122, and/or other data. The storage device 1014 can be connected to the computer 902 through a storage controller 1022 connected to the chipset 1006, for example. The storage device 1014 can consist of one or more physical storage units. The storage controller 1022 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 902 can store data on the storage device 1014 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 1014 is characterized as primary or secondary storage, and the like.

For example, the computer 902 can store information to the storage device 1014 by issuing instructions through the storage controller 1022 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 902 can further read information from the storage device 1014 by detecting the physical states or characteristics of one or more particular locations within the physical storage units.

In addition to the mass storage device 1014 described above, the computer 902 can have access to other computer-readable storage media to store and retrieve information, such as policies, program modules, data structures, and/or other data. It should be appreciated by those skilled in the art that computer-readable storage media is any available media that provides for the non-transitory storage of data and that can be accessed by the computer 902. In some examples, the operations performed by the cloud network 118, and/or any components included therein, may be supported by one or more devices similar to computer 902. Stated otherwise, some or all of the operations performed by the cloud network 118, and or any components included therein, may be performed by one or more computer devices 902 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 1014 can store an operating system 1016 utilized to control the operation of the computer 902. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 1014 can store other system or application programs and data utilized by the computer 902.

In one embodiment, the storage device 1014 or other computer-readable storage media is encoded with computer-executable instructions which, when loaded into the computer 902, transform the computer from a general-purpose computing system into a special-purpose computer capable of implementing the embodiments described herein. These computer-executable instructions transform the computer 902 by specifying how the CPUs 1004 transition between states, as described above. According to one embodiment, the computer 902 has access to computer-readable storage media storing computer-executable instructions which, when executed by the computer 902, perform the various processes described above with regards to FIGS. 1A-6. The computer 902 can also include computer-readable storage media having instructions stored thereupon for performing any of the other computer-implemented operations described herein.

The computer 902 can also include one or more input/output controllers 1024 for receiving and processing input from a number of input devices, such as a keyboard, a mouse, a touchpad, a touch screen, an electronic stylus, or other type of input device. Similarly, an input/output controller 1024 can provide output to a display, such as a computer monitor, a flat-panel display, a digital projector, a printer, or other type of output device. It will be appreciated that the computer 902 might not include all of the components shown in FIG. 10, can include other components that are not explicitly shown in FIG. 10, or might utilize an architecture completely different than that shown in FIG. 10.

As described herein, the computer 902 may comprise one or more devices, such as a network device 206, user devices 106, routers 108, control plane devices 120, a device of control plane 208, and/or other devices. The computer 902 may include one or more hardware processors 1004 (processors) configured to execute one or more stored instructions. The processor(s) 1004 may comprise one or more cores. Further, the computer 902 may include one or more network interfaces configured to provide communications between the computer 902 and other devices, such as the communications described herein as being performed by a network device 206, user devices 106, routers 108, control plane devices 120, a device of control plane 208, and/or other devices. In some examples, the communications may include data, packet, instructions, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 1018 may comprise any type of programs or processes to perform the techniques described in this disclosure in accordance with data traffic sovereignty protection techniques. For instance, the programs 1018 may cause the computer 902 to perform techniques for communicating with other devices using any type of protocol or standard usable for determining connectivity. Additionally, the programs 1018 may comprise instructions that cause the computer 902 to perform the specific techniques for data traffic sovereignty protection.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving, at a controller device and from a head end device, a path computation request for a data path for data traffic across a network to a destination device;
receiving, at the controller device, a geographic location of at least one network device of the network;
receiving, at the controller device, a sovereignty policy related to the data traffic;
computing, by the controller device, the data path for the data traffic based at least in part on the geographic location of the at least one network device and the sovereignty policy; and
sending, by the controller device and to the head end device, the data path for the data traffic.

2. The computer-implemented method of claim 1, wherein the computing the data path further comprises:
determining that the geographic location of the at least one network device complies with the sovereignty policy; and
including the at least one network device in the data path.

3. The computer-implemented method of claim 2, wherein the geographic location of the at least one network device is located within a Geo-Boundary included in the sovereignty policy.

4. The computer-implemented method of claim 1, wherein the computing the data path further comprises:
determining that the geographic location of the at least one network device does not comply with the sovereignty policy; and
excluding the at least one network device from the data path.

5. The computer-implemented method of claim 1, wherein the at least one network device is a mobile network device, and computing the data path further comprises:
determining an updated geographic location of the mobile network device;
determining an updated data path for the data traffic based at least in part on the updated geographic location of the mobile network device and the sovereignty policy; and
sending, by the controller device and to the head end device, the updated data path for the data traffic.

6. The computer-implemented method of claim 1, wherein the sovereignty policy comprises a Data Sovereignty Protection Intent (DSPI).

7. The computer-implemented method of claim 6, wherein the geographic location of at least one network device is received in a Link state Type/Length/Value (TLV) format.

8. The computer-implemented method of claim 6, wherein the controller device is a segment routing-path computation element (SR-PCE) controller and the sovereignty policy is received in a Path Computation Element Protocol (PCEP) Sub-Type/Length/Value (Sub-TLV) message.

9. A controller device comprising:
one or more processors; and
one or more non-transitory computer-readable media storing computer-executable instructions that, when executed by the one or more processors, cause the one or more processors to:
receive, from a head end device, a path computation request for a data path for data traffic across a network to a destination device;
receive a geographic location of at least one network device of the network;
receive a sovereignty policy related to the data traffic;
compute the data path for the data traffic based at least in part on the geographic location of the at least one network device and the sovereignty policy; and
send, to the head end device, the data path for the data traffic.

10. The controller device of claim 9, wherein the computer-executable instructions further cause the one or more processors to:
determine that the geographic location of the at least one network device complies with the sovereignty policy; and
include the at least one network device in the data path.

11. The controller device of claim 10, wherein the geographic location of the at least one network device is located within a Geo-Boundary of the sovereignty policy.

12. The controller device of claim 9, wherein the computer-executable instructions further cause the one or more processors to:
determine that the geographic location of the at least one network device does not comply with the sovereignty policy; and
exclude the at least one network device from the data path.

13. The controller device of claim 9, wherein the at least one network device is a mobile network device, and wherein the computer-executable instructions further cause the one or more processors to:
determine an updated geographic location of the mobile network device;
determine an updated data path for the data traffic based at least in part on the updated geographic location of the mobile network device and the sovereignty policy; and
send, to the head end device, the updated data path for the data traffic.

14. The controller device of claim 9, wherein the sovereignty policy comprises a Data Sovereignty Protection Intent (DSPI).

15. The controller device of claim 14, wherein the geographic location of at least one network device is received in a Link state Type/Length/Value (TLV) format.

16. The controller device of claim 9, wherein the controller device is a segment routing-path computation element (SR-PCE) controller and the sovereignty policy is received in a Path Computation Element Protocol (PCEP) Sub-Type/Length/Value (Sub-TLV) message.

17. A method comprising:
receiving, at a controller device and from a head end device, a path computation request for a data path for data traffic across a network to a destination device;
receiving, at the controller device, a geographic location of a network device of the network;
receiving, at the controller device, a sovereignty policy related to the data traffic;
using the geographic location of a network device, determining, by the controller device, a sovereignty authenticity index (SAI) value for the network device;
computing, by the controller device, the data path for the data traffic based at least in part on the SAI and the sovereignty policy; and
sending, by the controller device and to the head end device, the data path for the data traffic.

18. The method of claim 17, wherein the SAI value indicates whether the geographic location of the network device complies with the sovereignty policy.

19. The method of claim 18, wherein computing the data path further comprises:
in a first instance where the SAI value indicates that the geographic location of the network device complies with the sovereignty policy, including the network device in the data path; and
in a second instance where the SAI value indicates that the geographic location of the network device does not comply with the sovereignty policy, excluding the network device from the data path.

20. The method of claim 19, wherein the network device comprises a mobile router and the method further comprises:
determining an updated geographic location of the mobile router;
checking the updated geographic location for compliance with the sovereignty policy; and
re-computing the data path in an instance where the updated geographic location is not in compliance with the sovereignty policy.
